(19) United States
(12) Patent Application Publication
(10) Pub. No.: US 2014/0152017 A1
(43) Pub. Date: Jun. 5, 2014

(54) SYSTEM OF FLOATING PLATFORMS FOR GENERATING ELECTRICITY BY WIND TURBINES

(71) Applicant: Gurcharan Singh Bhusri, Holmdel, NJ (US)

(72) Inventor: Gurcharan Singh Bhusri, Holmdel, NJ (US)

(21) Appl. No.: 13/692,890

(22) Filed: Dec. 3, 2012

(51) Int. Cl. H02K 7/18

(52) U.S. Cl. CPC H02K 7/1838
USPC 290/55

(57) ABSTRACT

Wind turbines are installed on floating platforms. Each platform is connected to a central platform in a star like topology. Energy generated from a group of floating platforms is sent to the central platform over under sea coaxial cables. The central platform is connected via a transformer to the national electricity grid on shore. The grid is national in scope and transports energy to serve the needs for electricity for the whole country, such that multiple sources of generation and multiple utilities connect to it at various locations. The utilities distribute the electricity to customers in their jurisdiction. Solar panels can be mounted on racks between rows/columns of wind turbines. The central platform has housing/shelter/building for equipment used for integration as well as for management of turbines and solar panels.

### BACKGROUND OF THE INVENTION

The present invention relates to generation of electricity using wind turbines and more specifically to wind turbines installed on floating platforms.

Energy is a basic need for survival of humanity on planet earth. Irrespective of the fact that United States is blessed with abundance (relative to most other nations) of fossil fuels including oil, natural gas and coal, the use of these energy sources is responsible for raising the temperature of the planet and polluting our environment. Even if man manages to survive the changes inherent in consumption of fossil fuels, these fuels are not inexhaustible and the age of these fuels will come to an end eventually.

Fortunately the ocean holds the key to renewable resources which can sustain the life on this planet forever. The most abundant and cost effective source of energy is wind.

Wind is one of the most attractive renewable energy resources. The cost of generating one kilowatt hour of electrical energy using wind is estimated to be less than 7 cents compared with 14 cents for nuclear and 20 cents for solar. The cost of wind and solar are 4-5 cents and 12-15 cents per kwhr when federal and state credits are included. Also these costs continue to trend down as a result of progress in technology and manufacturing efficiencies.

However, citizens have objected to wind farms next to the coast. Because of the limit of human vision there is no objection if the wind farms are more than 4 miles away from the coast (in sparsely populated coast lines) since the blades can be made of color grey, merging seamlessly with the sky and satisfying the esthetic concerns of the citizenry.

In large cities, high rise buildings make it possible for citizens to view and object to a sight of wind turbines. Also in these places, demands for commercial shipping traffic needs to be considered. These esthetic and commercial considerations dictate that wind farms be deployed beyond 10 miles from the coast in the vicinity of large cities.

Therefore, there is a need for a method of producing electricity that harnesses wind energy while deployed miles away from the coastline so as to be out of sight.

### SUMMARY OF THE INVENTION

In one aspect of the present invention, wind turbines are installed on floating platforms. Each platform is connected to a central platform in a star like topology. Energy generated from a group of floating platforms is sent to the central platform over under sea coaxial cables. The central platform is connected via a transformer to the national electricity grid on shore. The grid is national in scope and transports energy to serve the needs for electricity for the whole country, such that multiple sources of generation and multiple utilities connect to it at various locations. The utilities distribute the electricity to customers in their jurisdiction.

The grid of electric power is interconnected system that moves electricity around the country and has standards for AC voltage and frequency for interconnection. The transmission over the grid requires high voltage to minimize transmission losses. Accordingly a transformer converts the voltage generated by wind turbines to the higher voltage required by the grid. A utility connected to the grid does the reverse in that it uses transformer(s) to convert from a high to lower voltage for distribution to end customers.

In another aspect of the present invention, solar panels are mounted on racks between rows/columns of wind turbines. The energy generated by solar panels is Direct current (DC). The energy generated from solar panels is converted to alternating current, voltage and frequency consistent with that produced in each turbine, before the two are integrated for transmission to the grid via the above said transformer. The energy from solar panels uses the valuable real-estate of the floating platform and complements the energy from wind to enhance the efficiency of the energy producing enterprise.

In yet another aspect of this invention the central platform has housing/shelter/building for equipment used for integration as well as for management of turbines and solar panels. The equipment and crew are referred to as Operations Center. It manages the flotilla and forms the on-site nerve center. Surveillance of the environment for protection against harm is of utmost importance. To this end miniature cameras along with night vision devices are embedded in the nacelle of each turbine. The Operations Center building also serves as a light house such that commercial traffic stays away from the flotilla. The lighthouse is also equipped with similar cameras and night vision devices.

The Operation Center is equipped with consoles that display each component of the flotilla on the map along with its status. It has visibility extending 10-15 miles and upon detecting a suspicious event can launch a drone/pilotless plane for further investigation and report.

These and other features, aspects and advantages of the present invention will become better understood with reference to the following drawings, description and claims.

### BRIEF DESCRIPTION OF THE DRAWINGS

FIG. 1 is an exemplary embodiment of the invention illustrating the architecture of off-shore wind farm flotillas;

FIG. 2 is an exemplary embodiment of the invention illustrating air craft carriers for off-shore wind farm security;

FIG. 3 is an exemplary embodiment of the invention illustrating representation of an off-shore ‘Mother’ wind farm platform;

FIG. 4 is an exemplary embodiment of the invention illustrating a representation of an off-shore ‘child’ wind platform; and

FIG. 5 is an exemplary embodiment of the invention illustrating a representation of an off-shore ‘Mother’ wind/solar hybrid platform.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a modular system of off-shore floating wind turbine platforms for generating electricity. As described in greater detail below, there are several differences between conventional land-based systems and the off-shore wind turbine system according to embodiments of the present invention. Table 1 below outlines some of these differences.

TABLE 1
Differences Between Land Based Systems Versus Off-shore
Wind Turbine Systems according to subject invention

| | | Off-shore Systems according to |
|---|---|---|
| Characteristic | Land Based Systems | the present invention |
| Wind quality | Varies depending on | Abundant and more uniform. |
| | location, height of | Velocity and density of wind is |
| | turbine tower speed | far better. (Wind class 5 or 6 |
| | and density of wind. | along most of the coast) No |
| | Affected by | obstructions. Height of turbine |
| | obstructions to wind | tower matters. Since energy |
| | by trees, buildings, | output varies as cube of speed, |
| | or the like | this provides a very significant |
| | | advantage over land based |
| | | systems. |
| Turbine | Installation fixed on | Installation on floating platform. |
| | pedestal or Jacket | Design of platform uses proven |
| | Tower, favors | technology developed for drilling |
| | highest capacity | oil as well as sea vessels |
| | turbines. Major | transporting heavy loads. Small |
| | cost component | to medium capacity turbines |
| | is turbine. Land | preferred. Large turbines a |
| | cost a minor | future possibility. Must use |
| | component. | anticorrosive materials. |
| Cost of | Ideal wind sites are | Energy is produced within 4-15 |
| Electricity | far away from | miles from the major |
| Transmission | the coastal cities | consumption centers along the |
| | which consume | coast of United States. Minimal |
| | 78 percent of | loss for transmission. |
| | all electricity. | |
| Surveillance | Little or none. | 24/7 Surveillance of the |
| for security | Fencing if needed. | environment absolutely |
| | | essential. Embedded and |
| | | extensive surveillance that |
| | | extends to national coast and |
| | | provides potential for reducing |
| | | coast defense costs. |
| Ambient | Sources of this | The surface of the sea has no |
| Turbulence | intensity are forests, | friction and no possibility of any |
| Intensity | hills, cliffs and | thermal effects. There is no |
| | thermal effects. | ambient intensity whatsoever. |
| Aesthetics | Objection of citizens | Not an issue. Wind turbines out |
| | to spoiling natural | of sight. |
| | sites/ Not-in-my- | |
| | backyard issues. | |
| Collision with | Can be a major | None to minor problem. |
| Birds etc | problem. | |
| Total Capacity | Suitable sites are | A modular and scaleable |
| of Energy | limited. Total | solution. Suitable sites along |
| Produced | energy produced | most of the coast (12000 miles), |
| | falls far short of | four miles out and beyond. The |
| | national needs. | product of number of sites X |
| | | number of flotillas at each site X |
| | | number of platforms/flotilla X |
| | | number of Turbines/platform X |
| | | capacity of each turbine provides |
| | | multiple paths to yield all of the |
| | | future expected needs for |
| | | electricity in United States. |

Referring to FIG. 1, an exemplary embodiment of the invention depicts flotillas. A group of one Mother platform and one or more Child platforms supported by 1-2 Ferries is referred to as a flotilla. A flotilla is comprised of one Mother and 6 or more Child platforms. Each Mother platform is connected to a National Electric Grid having multiple points to allow termination of the off-shore flotillas. The points of interconnection are protected by physical security against vandalism and harm due to surges. The transformers needed to ensure the voltage is compatible with the National Grid are housed at the termination points or housed next to the Operations Management Center in the mother platform.

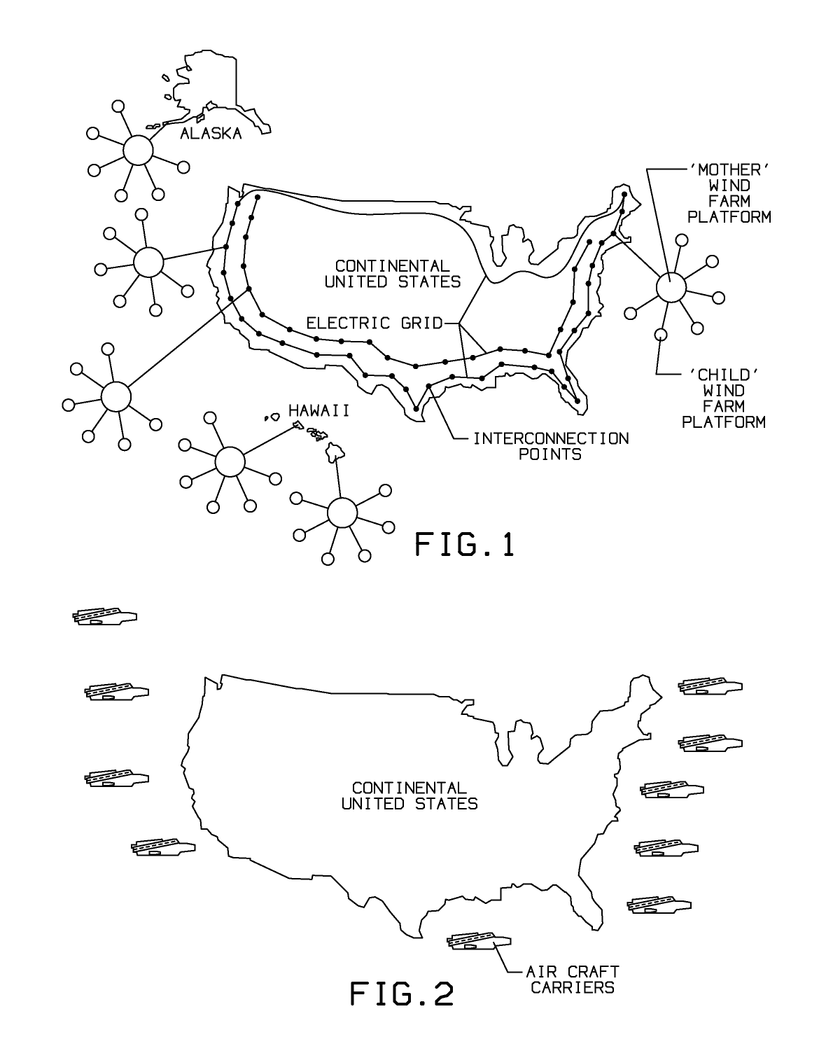

Referring to FIG. 2, an exemplary embodiment of the invention shows air craft carriers along the coast of the United States. These aircraft carriers may be those that have retired from active duty and converted to peaceful defensive purposes or similar custom designed platforms to perform (a) protection of the Flotillas (b) national defense (c) coast guard coordination and (d) as security points for incoming and outgoing naval and commercial vessels. The aircraft carriers deploy drones and GPS services for surveillance of vessels.

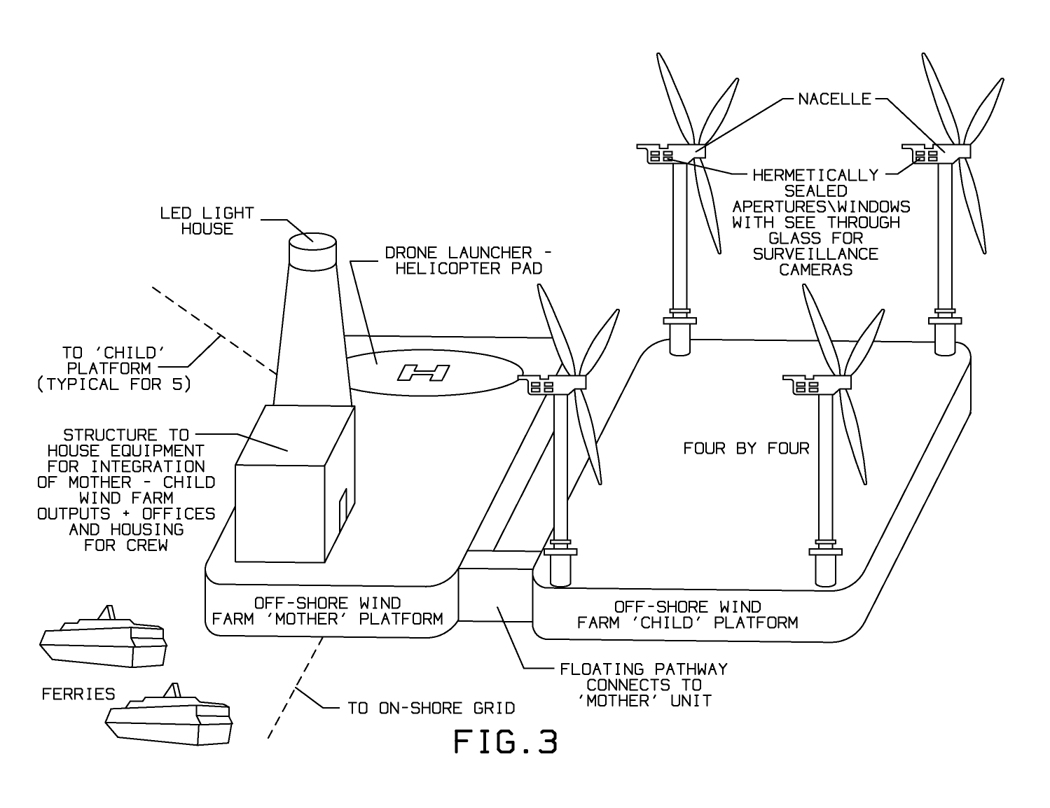

Referring to FIG. 3, an exemplary embodiment of the invention shows a Mother platform and a Child Platform with up to 16 Turbines. The Mother platform has a shelter for housing equipment and living quarters for the crew managing the Flotilla, a light house with LED lights as cautionary signaling indicators to commercial traffic. The light house also contains surveillance cameras. The platform also has a helicopter/drone launching pad. Also shown in the drawing are Ferries serving equipment transportation needs for equipment and crew.

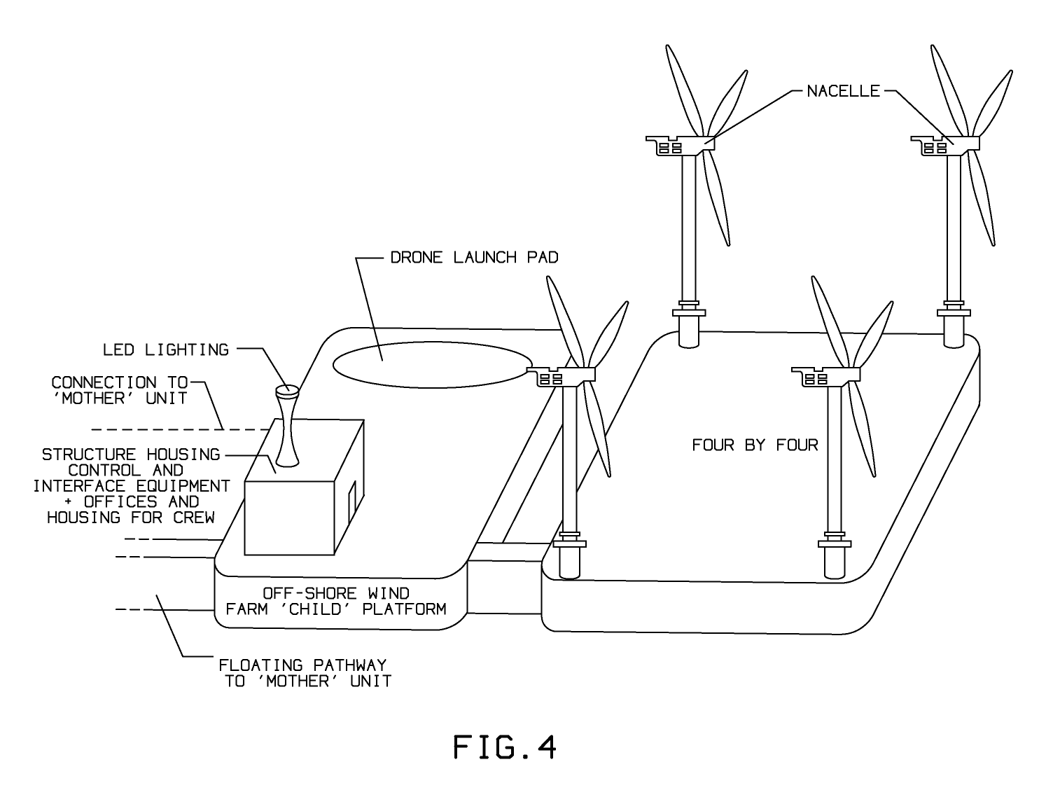

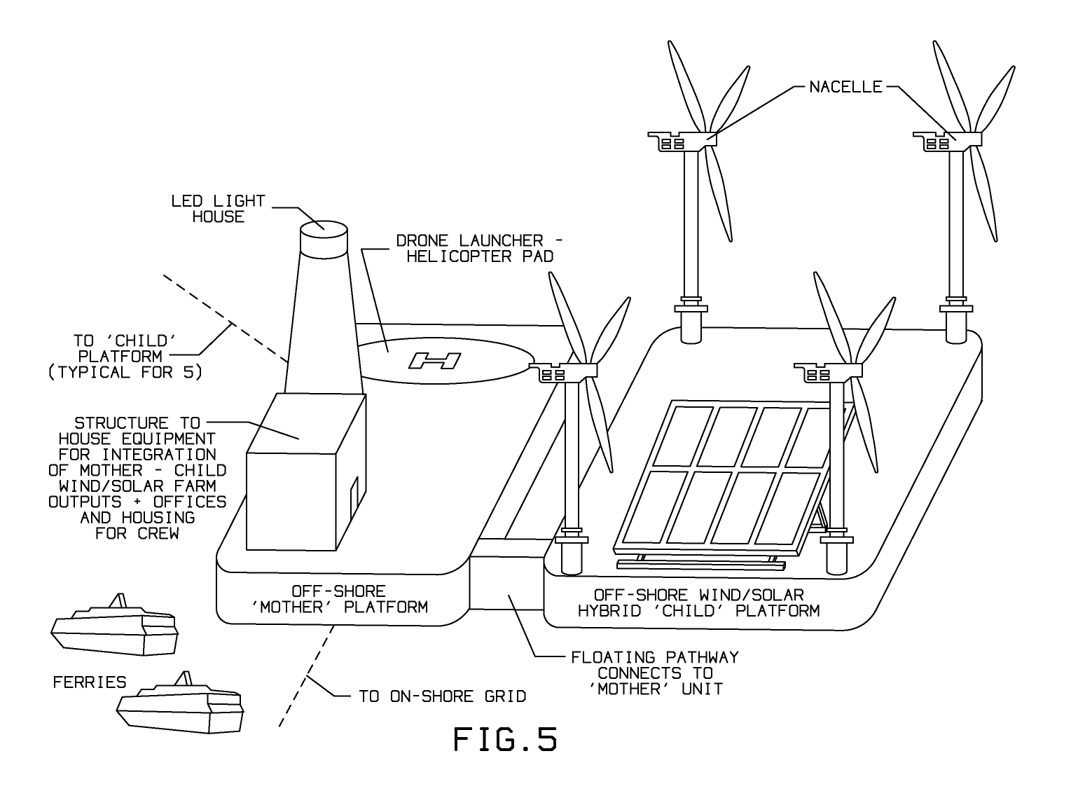

Referring to FIG. 4, an exemplary embodiment of the invention shows a Child platform. For simplicity only 4 of the 16 turbines are shown. The platform size and size and number of turbines are interdependent. A platform size which can support 16 small turbines, may only support 4 large turbines. The invention supports both approaches, i.e., larger number of small turbines or small number of large turbines. The objective in each case is that spacing between turbines does not exceed 5 rotor lengths in each row and 3 rotor lengths within each column. This minimizes fatigue of rotor blades due to turbulence caused by neighboring turbine resulting in fatigue and consequently shortened life span. Of course, the overall criteria is to achieve lowest cost for the whole enterprise for the energy produced by the flotilla.

The shelter provides housing for integration of electric output of up to 16 turbines. The child platform is designed for unattended operation and remotely managed from Operation Center in the mother platform. The submersible platform uses technology from oil rigs for dynamic positioning such that the platform adjusts to wind, waves and currents along with technology for stability proven in heavy load carrying commercial vessels.

Referring to FIG. 5, an exemplary embodiment of the invention shows a child platform with wind turbines and solar panels. Although the energy from solar panels has not been considered in the calculations, it is complementary to wind energy and may be taken advantage of when appropriate. This is commonly referred to as a hybrid system. The energy produced by the solar panels is Direct Current (DC) in contrast to energy produced by a wind turbine. The direct current energy is converted to AC using an inverter before integrating the two forms of energy.

The child platform is a floating platform with up to 16 wind turbines installed on the platform (4 rows of 4 turbines each) and each turbine capable of generating approximately 2 Megawatts of electricity (or 4 large turbines generating 8-10 Megawatts of electricity each). Each turbine in addition to converting wind energy to electric energy is also equipped with miniature cameras located in the nacelle for surveillance. The surveillance capability is not only to guard against threats to the flotilla but also extends to the coast line in support of the national coast guard's mission to protect against terrorists and attempts at illegal entry on shore.

A child platform will have a shelter for housing equipment for integration of energy from the wind turbines (and solar when applicable) and sending to the mother platform. On one side of the platform adjoining the turbine installations is a helicopter landing pad and a drone launching platform. Drones are launched for surveillance and to respond to threats on command from the mother or father platform.

One Mother platform may manage 6 or more child platforms. The shelter contains equipment for integrating electricity from all Child platforms and computer consoles for monitoring and control of the entire flotilla. The shelter also contains equipment for termination of transmission cables which are connected at defined points on the national grid onshore.

The shelter contains computer equipment, diagnostic software, maps and display consoles, to perform all functions required of Operations Center for the flotilla. The status of equipment on all platforms is displayed at all times. The results of camera surveillance are visible in real time. The schedule of surveillance by drones and results of previous such surveillance are also logged.

The shelter contains computer equipment for determination of wind velocity and direction and for orientation of turbines for generating optimum operation and if necessary under emergency conditions to shut off one or more turbines. In addition computer communication equipment in the shelter provides access to the national internet, telephone, cable and broadcast networks.

The shelter provides housing for the crew managing the Operations Center.

The invention also includes ferries, which serve the need for transporting equipment, material and consumables among the members of a flotilla. They are also responsible for clearing debris gathered at the boundary of the flotilla. A floating tube encircling a flotilla may be used to form a temporary barrier for the debris until it is collected and disposed of by the crew assigned to the ferry. One Ferry is an integral part of each flotilla. However ferries are a shared resource and assigned based on work load. Thus flotillas may temporarily take advantage of neighboring Ferries based on sharing workloads.

Each mother/child platform is equipped with a wire mesh fence to prevent sea animals jumping on the platform and creating hazards and possibly impacting a flotilla's operations.

The function of the floating tube is to prevent clutter from entering the flotilla circle and to form a barrier for incoming debris which are collected and disposed of by the crew of the ferries.

The father platform is a legacy aircraft carrier converted to defensive role after its retirement on active naval duty. It will retain a few aircrafts and 1-2 helicopters for the new mission to defend the coast and the Flotillas. The conversion will involve assigning one flotilla to generating power for the aircraft carrier such that during peace times, the needed power for operations is derived from wind and solar sources. It would retain the capability to fall back on its nuclear plant under emergency conditions. The Father platform will also serve as advance security check point for incoming commercial/naval ships as they enter national waters. Patrol boats in cooperation with pilotless planes (drones) will identify incoming ships and escort them to the Father platform for security clearance before moving forward to their intended destination (be it New York, Boston, Houston, Los Anglos or San Francisco etc.).

A paradigm shift for hierarchical roles for management will take place to assist the coast guard and interface with Department Of Defense and other departments of the administration.

Attached to each Father platform are 1-2 counter insurgency racing boats. Their purpose is to chase, engage, capture and when unavoidable kill pirates, terrorists or other adversaries trying to attack or harm either the flotillas or the coast of the United States. Under normal times, they generate power for their own propulsion using kite like turbines but have natural gas engines as back-up when needed.

Patrol boats assigned to Father platform work in cooperation with pilotless planes (drones). They intercept incoming ships and escort them to the Father ship for security clearance before they move forward to the port.

The wind turbines are specifically designed for floating platforms. They employ materials with high strength to weight ratio and that are corrosion resistant. They are also designed to have capability for surveillance by cameras installed in the nacelle and be able to have a broad view through apertures/windows hermetically sealed with see-through plastic for the camera to take pictures of events of interest and submit and transmit it to the attendant consoles in the shelter.

The turbine is capable of supporting a gearbox in the nacelle to multiply the incoming rotor speed into higher speed driving the generator. The gearbox can be switched in when the speed of the wind is low for optimum operation. The gearbox is remotely controlled and can be switched in and out as needed.

The national grid is a national energy transmission network with designated points of termination along the entire coast of United States. The points of interconnection are physically (security) protected and electrically protected against harm by surges. The length of the United States coastline is approximately 12000 miles. As discussed earlier, approximately 500 to 1000 interconnection points may be required for a large scale deployment of flotillas to produce electricity presently produced by fossil fuels including coal, petroleum and natural gas.

The transformer required to convert to national standard high voltage for interconnection to the grid will be housed next to the Operations Center in the mother platform or alternatively at the interconnection point.

Satellites provide back-up communication as well as surveillance of the whole family of flotillas and continuously report events of interest to Father and Mother platforms.

Surveillance and security of the flotillas are integrated with security and protection of the coast line. Surveillance functions are incorporated in the wind turbines, light house, wireless towers. In addition drones continuously survey above the flotillas and beyond the national waters for suspicious events as well as all naval vessels headed toward the coast. In cooperation with the Father platforms and the patrol boats they serve as the eyes in the sky and serve multiple surveillance and report functions.

Electricity generation using off-shore flotillas is a new industry with a business model based on airline and oil/gas industries versus role of Government. Thus the Government gives licenses for operation of flotillas on an area by area basis. The manufacture of Flotillas including, turbines, platforms, ferries is domain of private industry. The operation of flotillas for generating electricity is also like the airlines, the domain of private companies. The Government is responsible for security aided by the operators of the flotillas.

Initial assembly and construction of child and mother platforms is done at a ship yard closest to location of operation. The shipping yard may be owned by the same company in case of a large operator of flotillas or the services are provided by third parties to operators of small/large number of flotillas. Fully assembled and tested flotillas are then towed to the location of operation. The mother platform is the first to be placed at its intended layout destination. The child platforms are then placed as per the layout. Connections of child platforms to mother platform and the mother platform to the grid is then accomplished. (Permits for interconnection to the grid are obtained at the start of a project).

Final step is testing and cutover of the flotilla onsite.

Day to day maintenance is done on site, but platforms are towed to the shipping yard for retrofit and evolution of turbines to a new more efficient generation of turbines.

It should be understood, of course, that the foregoing relates to exemplary embodiments of the invention and that modifications may be made without departing from the spirit and scope of the invention as set forth in the following claims.

What is claimed is:

1. A system of off-shore floating wind turbine platforms for generating electricity comprising:
a mother platform;
at least one child platform;
at least one ferry;
wherein each child platform contains multiple turbines for generating electricity.

2. The system of claim 1, wherein the mother platform comprises:
a shelter for housing equipment;
living quarters for crew members;
a lighthouse; and
a helicopter/drone launching pad.

3. The system of claim 1, wherein the child platform comprises:
from 4 to 16 turbines;
wherein the turbines are installed on the platform in 2 rows of 2 or any combination of rows and columns with a total number of turbines not to exceed 16 turbines.

4. The system of claim 3, wherein the turbines are equipped with miniature cameras located in the nacelle or in an embedded housing on a top of the turbine tower.

5. The system of claim 3, wherein the child platform further comprises solar panels.

6. The system of claim 1, wherein the Mother platform is connected to an electric grid having multiple points to allow termination of the off-shore Flotillas.

7. The system of claim 1, wherein the Mother platform further comprises at least one transformer for connecting electricity generated by the at least one child platform to an electric grid.

8. A system of off-shore floating wind turbine platforms for generating electricity comprising:
a mother platform;
at least one child platform;
at least one ferry;
wherein each child platform contains multiple turbines for generating electricity; and
the turbines include miniature cameras installed in the nacelle; and
the turbines are made from materials with high strength to weight ratio and corrosion resistant; and
the turbine is capable of supporting a gearbox in the nacelle to multiply the incoming rotor speed into higher speed driving the generator; and
the gearbox can be switched in when the speed of the wind is low for optimum operation.
